(19) United States
(12) Patent Application Publication
(10) Pub. No.: US 2007/0112613 A1
(43) Pub. Date: May 17, 2007

(54) Membership based skills data dissemination system

(75) Inventor: Noel Anthony Jones, St. Ives (AU)

Correspondence Address: LADAS & PARRY, 26 WEST 61ST STREET, NEW YORK, NY, 10023, US

(73) Assignee: THE-REGENERATION.COM PTY LIMITED.

(21) Appl. No.: 11/371,325

(22) Filed: Mar. 8, 2006

(30) Foreign Application Priority Data
Nov. 15, 2005 (AU) 2005234625

(51) Int. Cl. G06F 9/46

(52) U.S. Cl. 705/9

(57) ABSTRACT

A membership based skills data dissemination system; said system adapted to accept postings of personal skills data of respective ones of fee paying subscribing members; each subscribing member instigating and controlling their said personal skills data on a searchable database; said personal skills data including data comprising a description of at least one skill of each said subscribing member.

The present invention relates to systems and methods for advertising and making available an individual's skills and expertise to potential users of those skills and, more particularly to a system and method encompassing any skill in any field of human activity, including both vocational and non-vocational, domestic, recreational and educational skills.

### BACKGROUND

A side effect of the tendency in modern developed societies for a lengthening of the lifespan and moreover the lengthening of an active lifespan, is that many people who have retired or are no longer in full time employment, have skills and expertise which are then often wasted. As well, an increase in part-time and casual employment has led to an increasing pool of underemployed but potentially useful skills and expertise which is difficult to access.

Furthermore, it remains an unfortunate fact that many people who, for whatever reason, lose a position in the workforce in the latter part of what is considered a normal working lifespan, are then unable to find re-employment and suffer loss of self respect as well as loss of income.

Of some 5.5 million of Australia's population over the age of 45, some 3 million are not in full or part-time work and 77% of these do not have superannuation. Yet this subset of the population contains a high proportion of vocational skills, academic qualifications and time-developed practical skills and talents. Through negative employment bias and lack of outlet opportunities, these resources are largely wasted, imposing a high personal cost to those affected and significant losses to the community as well as the economy.

Many skill recruitment and matching systems are known which match the requirements of a potential employer with the professional or vocational skill of a potential employee. Some of these are restricted to a particular profession and in particular geographic areas, such as for example the system disclosed in U.S. 2001/0042000, which is specifically directed at the Information Technology industry.

Also known are systems which are adapted to grade potential applicants for available positions, such as described in U.S. Pat. No. 6,289,340 and U.S. 2003/0009437 for example.

Yet other systems are comprised of listings of available positions to which potential applicants can post resumes, such as that found in U.S. 2005/0177408.

Other such systems may be restricted to a skill database within a particular organization or an otherwise proscribed body of participants. An example may be found in U.S. 2003/0078821 where a skills database of a current cohort of employees is maintained for use in allocating projects and tasks based upon employee skills ascertained from the database. A feature of this system is that it is updated automatically under the control of management and with minimal if any input from the employees.

None of these allows an individual, him or herself to enter into a publicly searchable database a plurality of skills, expertise and talents which the individual is willing to provide to potential users, either on a permanent or ad hoc time basis. Nor do any of these systems provide a feedback facility to the individual to assist him or her to better describe the skills and expertise offered so as to improve their chances of attracting a potential user.

Yet a further disadvantage of known systems is that they do not facilitate communication between various individuals with similar or associated skills, who through such communication could offer an augmented skill set or service to potential users.

It is an object of the present invention to address or ameliorate some of the above disadvantages.

Note:

The term “comprising” (and grammatical variations thereof) is used in this specification in the inclusive sense of “having” or “including”, and not in the exclusive sense of “consisting only of”.

### BRIEF DESCRIPTION OF INVENTION

Accordingly in one broad form of the invention there is provided a membership based skills data dissemination system; said system adapted to accept postings of personal skills data of respective ones of fee paying subscribing members; each subscribing member instigating and controlling their said personal skills data on a searchable database; said personal skills data including data comprising a description of at least one skill of each said subscribing member.

Preferably said system further includes a feedback facility adapted to advising a said subscribing member on ways of optimizing content and format of said skills data.

Preferably said feedback facility provides advice to a said subscribing member based on statistical analysis of subscribing member and potential user interactions recorded by said database.

Preferably said feedback facility may include dissemination to a said subscribing member of articles and other information relevant to any skill of said subscribing member retained on said database.

Preferably said wide ambit of skills includes both vocational and non-vocational skills.

Preferably said non-vocational skills include skills associated with recreational activities.

The system of claim . . . wherein said non-vocational skills include skills associated with domestic activities

Preferably said non-vocational skills include educational skills.

Preferably said at least one skill includes skills offered by a said subscribing member on a permanent basis.

Preferably said at least one skill includes skills offered by a said subscribing member on an ad hoc time basis.

Preferably said at least one skill further includes skills offered on a remuneration basis.

Preferably said at least one skill includes skills offered by a said subscribing member on a voluntary basis.

Preferably said subscribing member of said system accesses said database for entry of said skills data over a distributed computer network such as the Internet.

Preferably membership of said system is open to any individual subscriber regardless of geographic location.

Preferably said skill data of a said subscribing member remains resident on said database indefinitely on payment of annual subscription renewal fees.

Preferably said database includes a search facility available to potential users of said skills; said search facility accessible over said distributed computer network.

Preferably said search facility is free to any said potential users at a first level of search criteria; said search criteria including at least a selected said skill.

Preferably said search facility attracts a fee at a second level of search criteria; said search criteria including specific skill experience.

Preferably search criteria available to a said potential user for searching in said database includes a variable geographic area delimiter.

Preferably said geographic area delimiter is a nominated radial distance from a geographic location.

Preferably said nominated radial distance is set by means of a slider bar displayed in a search criteria screen of said database.

Preferably said system includes a facility for establishing contact between a managing entity of said database and a said subscribing member.

Preferably said database includes a facility for establishing contact between a said potential user and a said subscribing member.

Preferably said database includes a contact facility for contact between subscribing members; said facility adapted to allow subscribing members to exchange information.

Preferably said contact facility is adapted to allow two or more subscribing members to offer a combination of said skills to a said potential user.

Preferably said system includes a facility for a said potential user to provide feed-back on aspects of said database; said aspects including, reports of successful searching and unsuccessful searching and comments and criticisms.

Preferably said database is adapted to provide statistical analysis to a said subscribing member of relevance of a skill offered by said subscribing member; said relevance assessed against recorded search criteria entered into said database by said potential users.

Preferably said database is adapted to provided qualitative assessment of skill data of a particular said subscribing member; said qualitative assessment based on comparison of perusal of said skill data of said particular subscribing member and other subscribing members with similar skill data.

Preferably said subscribing member may iteratively amend skill data maintained on said database.

In yet a further broad form of the invention there is provided a system for dissemination of skills; said system including a plurality of subscribing members offering skills to potential user of said skills; said skills of a subscribing member described in skill data; said skills data deposited in a web-based skills database at the initiation and under the control of said subscribing member; said skills data retained on said database for free searching by a said potential user.

Preferably said skill data includes skill data in a wide ambit of skills, including vocational and non-vocational, domestic, recreational and educational skills.

Preferably said at least one skill offered by a said subscribing member is offered on permanent and ad hoc time bases.

Preferably said at least one skill offered by a said subscribing member is offered on fee payable and voluntary bases.

Preferably said database is provided with analysis facilities adapted to provide feedback information to said subscribing members; said feedback information including assessment of effectiveness of skill data provided by a said subscribing member.

Preferably said database is provided with communication facilities between a managing entity of said database and said subscribing members.

Preferably said database is provided with communication facilities between said subscribing members and said potential users of said skills.

In yet a further broad form of the invention there is provided a method of making available skills of a plurality of subscribing members of a skill dissemination system to potential users of said skills; said skills described in skill data retained in a web-based database; said skill data freely searchable in said database by said potential users of said skills; said method including the steps of:
(a) an individual becoming a subscribing member of said skill dissemination system on payment of a subscription fee,
(b) said subscribing member entering into said database descriptive data relating to at least one skill offered for use by said member,
(c) receiving enquiries regarding availability of provision of said at least one skill by potential users of said at least one skill.
   Preferably said method includes the further steps of:
(d) said database providing feedback on effectiveness of said descriptive data,
(e) said subscriber provided with facility to amend said descriptive data,
and wherein said subscribing member retains editorial control over said descriptive data.

### BRIEF DESCRIPTION OF DRAWINGS

Embodiments of the present invention will now be described with reference to the accompanying drawings wherein:

FIG. 1 is a schematic representation of a preferred embodiment of a membership based skills data dissemination system according to the invention,

FIG. 2 is a flow diagram of one process within the system of FIG. 1,

FIG. 3 is a block diagram of the major interactions between the system of FIG. 1, subscriber members of the system and potential users.

FIG. 4 is an example of a data entry screen made available to subscribing members of the system of FIGS. 1 to 3.

### DETAILED DESCRIPTION OF PREFERRED EMBODIMENTS

The system of the present invention offers a way in which individuals themselves may deposit into a skills database information about skills, experience and talents which they possess and which they would like to make available to others, whether it be for payment or on a voluntary basis. Many people retired or otherwise unemployed or underemployed would be happy to make some gainful use of any of the skills and talents which they have acquired. Currently however, those skills and talents are usually wasted for lack of a system which can bring into contact those willing to provide and those who could make use of them.

The present system provides an on-line trading bank of skills and talents for fee paying subscribing members which may be freely accessed by any potential user. Thus the system provides potential access to “tacit” knowledge. Tacit knowledge may be described as that knowledge which resides as know-how, talent and skills in individual brains, and may be distinguished from explicit knowledge which includes forms of intellectual, creative or information assets which may be digitally stored, retrieved, manipulated and disseminated.

Thus potential users of the system, which may include private individuals, employers, government agencies and other organizations, are provided with a resource in which searches can be conducted for skill and talent sets, rather than just for a professional or trade category.

### First Preferred Embodiment

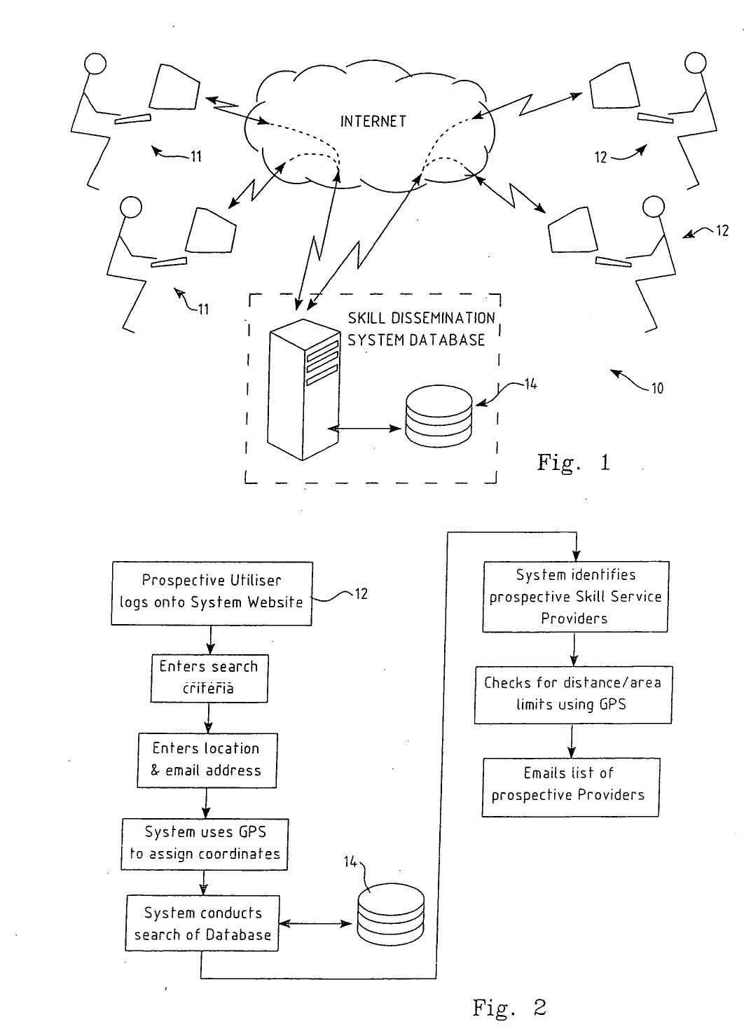

With reference to FIG. 1, a skill dissemination system 10 includes subscribing members 11 who desire to offer one or more of their skills to potential users 12 of those skills. The dissemination system 10 is web based and application for membership and entry of data into the system's database 14, is effected over the Internet 15. Membership requires payment of a fee which may comprise an initial joining fee and annual subscriptions.

Subscribing members may enter into the database maintained by the system, one or more skills which the entity believes he or she can provide. The skill set data is maintained on the database indefinitely on payment of annual subscription renewals.

The skills offered may be those of a wide ambit of skills including those of a trade or profession, be associated with some form of recreation or the provision of some service, be it for a fee or on a voluntary basis. Optionally, the listed skills may be accompanied by short advertising statements.

The skills offered may range across anything that one person can provide as a benefit to another. Apart from vocational skills, it may include such varied activities as training or walking a dog, constructing a garden, teaching bridge, offering to assist at a sporting event etc.

As well as entitling a subscribing member to the listing a number of skills accompanied by some optional advertising statements, the database entry may include a personal résumé.

Each member represented in the database will be referenced against his or her geographic location. The system will include an algorithm to translate the member's postal address into geographical coordinates by way of the Global Positioning System (GPS). Optionally some other data may be included, such as preferred times during which the offered skill/s may be made available and an area or distance limitation outside of which the skills are not offered.

The system provides an on-line search facility of the database to potential users of any of the skills offered by the subscribing members. Two entry levels to the database are envisioned; a basic free level and a more specialised level available for a fee. This second level will be described below under the head of Second Preferred Embodiment.

The basic process is illustrated in the flow diagram of FIG. 2. The first entry level allows any potential user of a particular skill or service to log on to the system website and enter the database with selected search criteria. At this entry level these criteria may simply be restricted to the skill or service sought, the geographical location (in the form of a postal address) and the email address of the potential user.

The system employs Statistical Word Association (SWA) algorithms to rate each member's skills based on the list of skills, associated advertising text and resume where available, to match a potential user enquiry with the skills retained in the database. The geographical coordinates of both the potential user and any distance and area limitations nominated by prospective provider subscribing members are taken into account in compiling a list of suitable prospective members.

The system then by return email provides the potential user a list of the most relevant available prospective provider subscribing members for the skill or service sought, ranking them according to their proximity to the potential user. The use of the GPS system to rank prospective provider subscribing members according to their proximity to a potential user, removes any unfair bias in selecting the potential provider members for presentation.

Also provided is a contact address, either an email address or telephone number, preferably a mobile telephone number. The email address may be a direct address of the subscribing members if these have elected to be so contactable, or may be that of the skill dissemination system which then acts as a “post office” to establish an initial contact between a selected member and the potential user.

Actual negotiations regarding the provision of the skill or service, any charges, times etc., are then solely between a selected member and the potential user. The skill dissemination system acts purely as a skill information broker and plays no further part in the transaction.

### Second Preferred Embodiment

A subscribing member may elect to simply advertise his or her vocational skills and qualifications. In this case the database entry will be restricted to searches by prospective employers (“buyers”) who, for a small fee are given access to the database at the second level of criteria referred to above.

Search criteria may now include more specific skill and experience requirements, location limitations and salary level for example. The search facility then allows a prospective employer, the buyer, to easily obtain a listing of the most suitable, nearest prospective employee/s.

Qualifying buyers are further provided with the option of conducting periodic searches for suitable subscribing members answering to a range of certain skill sets or backgrounds. The system emails these buyers with the results on payment of a fee.

### Third Preferred Embodiment

The system makes provision for subscribing members who are still currently in full time employment but who are contemplating the possibility of actively using their skills, be it vocational or non-vocational, after retirement. These members may subscribe to the system at a special level accessible for searching only by qualifying organizations which may be looking for specialised skills, such as for example, executive mentoring, non-executive roles, high level trade skills and consultancies.

### Fourth Preferred Embodiment

The system is adapted to retain a large range of data relating to the skills, experience and by inference, preferences of a large number of subscribing members. Inherent in this data is the ability for profiling for specific marketing of goods and services. Depending on prevailing privacy laws and the express permission of individual subscribing members, the system can provide specialised profile information for fee-paying clients.

The system described in the above embodiments provides a single repository that contains comprehensive ranges of skills from its subscribing members not previously available to the community. It therefore permits the advertising of multiple skills of an individual free of the restrictions of vocational classifications and reference to employers' requirements. By maintaining a spectrum of skill on the database of the system, a subscribing member may appear in multiple search results, thus greatly enhancing the possibility of satisfying and in many cases, obtaining gainful use of his or her skills.

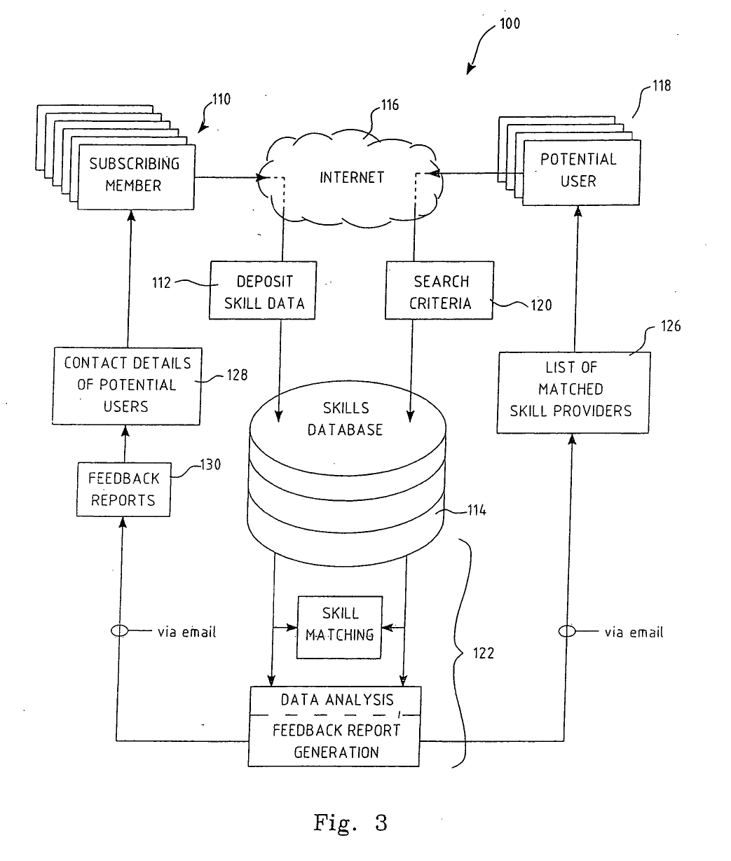

As shown in FIG. 3, the dissemination system of the invention is realised on media 20 programmed to provide digital data storage 22, input and retrieval means including server 24, and central processor 26.

### Fifth Preferred Embodiment

With reference to FIG. 3, a membership based skill data dissemination system 100 again includes a web-based skills database 114 accessible over the Internet 116 by both subscribing members 110 and potential users 118 of the skills described in skill data maintained on the database 114. The database 114 typically comprises microprocessor driven servers, digital storage devices and various I/O components for control of the system and communication with the Internet.

The skills database 114 is controlled by a managing entity responsible for all aspects of operating the database, maintaining subscriber records and accounts, and supplying to subscribing members information adapted to the optimal use of the services provided by the database.

Any individual may become a subscribing member 110 of the system on payment of an annual subscription fee. Subscriptions are not restricted geographically; any individual, wherever located, may become a subscribing member of the system. Once a subscribing member, he or she is personally able to enter skills and personal data 112 into the database 114 via user interface screens displayed on the subscribing member's computer.

A feature of the present system is that any of a wide ambit of skills, experiences or talents that the member wishes to make available, can be entered into the database. A wide ambit of skills for the purpose of this specification may be defined as including skills, experiences and talents in any field of human activity, including both vocational and non-vocational, domestic, recreational and educational. Optionally the subscribing member may include a personal resume in which particular aspects of skills, experiences or talents can be elaborated and which can serve to give a potential user a fuller appreciation of the individual who is offering his or her services.

Another feature of the system is that the skills or talents offered for use to potential users can be for any predefined or negotiated time span; thus a skill may be offered on a permanent or an ad hoc basis. Also some skills and talents may be offered on a voluntary basis, for example to potential users which are charities or other community serving organizations.

Yet a further feature of the present embodiment of the system, is that the system is provided with analytical sub-routines 122 which can analyse both the patterns of search criteria 120 used by potential users 118 accessing the database, and the skill, experience and talent information provided by subscribing members. This analysis, using the (SWA) algorithms referred to above, may be used by the system to generate feedback reports 130 to a subscribing member 110 indicating the degree of relevance of the information provided to the search criteria used in seeking a similar or associated skill profile. These feedback reports offer the subscribing member a resource for optimising the content and format of their skill data to increase the probability of it matching the most likely to be used search criteria.

The database is freely available for searching by potential users. No information related to a specific potential user is retained on the database and a potential user is not able to post a position vacant for example, to solicit for applicants. A successful search will return one or more subscribing members offering skills, experience or talents which are relationally associated in the database to the keywords used in the search. If the search returns more than one suitable subscribing member, these are listed in order of geographic proximity to the potential user. Each time a potential user's search returns a match with a member's skill data, that member is advised of the contact by email, and may respond to the potential user if desired.

Again, as described for the First Preferred Embodiment above, the system if so authorized, supplies to the potential user a contact address for any or each suitable subscribing member, either an email address or telephone number. The email address may be a direct address or that of the managing entity of the system which then acts as a “post office” to establish an initial contact between the subscriber member/s and the potential user.

A record is made of the skill, experience or talent sought by a search for statistical purposes. As well the analytical subroutines of the software assess the keywords used in the search and the number of “hits” that those keywords elicit. These collated statistics and other captured data are used by the system in the provision of the feedback to subscribing members referred to above.

Statistical Word Association Module

Introduction

Relevancy in the production of member lists in response to search criteria is of critical importance. Until Re Generation encounters really high member volumes, the Global Positioning System (GPS) will take much of the heat from this argument. However, that said, the Re Generation model will ultimately be exported to areas of greater population so relevancy will be critical.

As a principle, SWA will determine the member selection, GPS will position them.

Definition

Statistical Word Association (“SWA”) is a method of establishing the relevance of words, their association with other words and skill descriptors that apply to each member when compared to a buyer's search criteria. SWA is applied to each Category 1 selection of Members and the sub-category skills contained therein—SWA produces a word association matrix for each category 1 which allows cross-functional skills and the textual descriptions to be compared for relevance. The matrix is built up as each new member enters skills and textual descriptions about the skills. The words contained within the matrix each have a counter, which is incremented by words that appear next/close or in the same advertising sentence, creating the basis of a statistical association.

Once a Buyer search is initiated, (the Buyer has/must have selected a skill category), the system knows which Category 1 matrix it is dealing with. SWA examines the text the Buyer has entered (to refine the search criteria) and then compares the words with those in the matrix and commences a rating calculation which gives prominence to the search criteria words and to associated words that may not be contained in the search criteria text. By rating the words and associated words SWA is able to refine which members have a higher rating (i.e. relevance) based on the matrix calculations.

One of the great tests of a search engine to give relevance is a single word search (criteria), particularly if that word has a number of meanings. e.g. Java—this could be the Island in Indonesia, the IT language or slang for coffee. In such a case, SWA would have prominent associated words in its matrix for all three, so it can group and determine a greater relevance for displayed search results.

Matrixes

Graphically, this is what it looks like

| | Word-1 | Word-2 | Word-3 | word-4 | Word-5 | word-6 | Word-7 | Etc |
|---|---|---|---|---|---|---|---|---|
| Word-1 | | 2345 | 1341 | 3456 | 212 | 35446 | | 3245 |
| Word-2 | 231 | | 2390 | 893 | 2345 | 6754 | 876 | |
| Word-3 | 1276 | 6543 | | 8765 | 7865 | 453 | 23 | |
| Word-4 | 7658 | 5432 | 9878 | | 3498 | 8790 | 456 | |
| Word-5 | 7658 | 5674 | 90987 | | 5643 | | 9807 | 10234 |
| Word-6 | 980 | 9879 | 6584 | 4563 | 6754 | | 765 | |
| Word-7 | 8768 | 8976 | 6547 | 9879 | 7658 | 8976 | | etc |
| Etc | | | | | | | | |

Some Rules

A Matrix is formed for each Primary Category—so includes all members & Sub-categories (Cat 2) under the Primary (Cat 1).

2. The source of the words comes from the Text supplied by each member in the resume and Category advertising section.

3. Only Nouns and Adjectives are taken, so there needs to be a stop-word file

4. The matrix is updated as each member joins. Having stripped Nouns and Adjectives from a members' text, if a (say) noun occurs 5 times, it is only added once in the matrix

5. The numbers in the matrix table above represent the number of times the words occur in the company on others. On the first line Word-2 has occurred 2,345 in the company of Word-1, however if Word-1 was supplied as a single query, Word-6 would have greater prominence.

Keyword Links

All nouns and Adjectives (Matrix words) are linked to their Member-ID's, similar to all keyword searches. Either RDMS link or flat files (faster and easily rebuilt)

Category 1 Links

See PB.02—Each member is linked to each Primary Category (Cat 1) they have entered. As described in the search criteria above—a Buyer must enter a Category 1 (by default), so the amount of members to be searched is reduced. Using this, ReGeneration has a context (for the search) and only a single matrix to search.

Names, Places and Unique Combinations Thesaurus

It will be apparent that certain names and word combinations will need to be tied together in the various matrixes. As an example business names are usually followed by “Pty, Ltd, Assoc, or Inc”. Similarly, word combinations such as “spare parts” or various tertiary degrees would need to be trapped together.

SWA maintains a file for these combinations, as it examines incoming data, an algorithm within the software checks for these and other combinations. For corporate names, these are added to the file to create a standardisation. Some combinations, such as “spare parts” would be required to set added manually by system administration. Where these combinations may be trapped “after-the-fact” the matrixes and links to the documents would be adjusted in a house-keeping process.

Processing

a) Examine each Word sequentially drawn from Buyers search text.
First Word—produce list of members (from Cat1) that are linked to this word—add 1 to counter for each word
Second and Subsequent Words—if Member-ID not in list add to list, add 1 to counter of all—continue through all search words.

b) Examine each Word sequentially from Buyers search text—match each word on matrix line and drawn from matrix line the top 3 occurrences of words on that line. If any of the three words are included in the Buyers' search text, they are excluded. Examine members linked to remaining words, add new Member-ID's to list of members—increment all Member-id counters by 1 or decimal i.e. if new word is third add 0.3 etc

Repeat through all words in search text.

### EXAMPLE

Assume Buyers Search Text has words—Word-1, Word-4, Word-5

From the Matrix above

| Word 1: | Word-6 | Word-4 | Word-7 |
|---|---|---|---|
| 35,446 | 3456 3245 | | |
| Word-4 | Word-3 | Word-6 | Word-1 |
| 9,878 | 8,790 | 7,658 | |
| Word-5 | Word-3 | Word-7 | Word-6 |
| 90,987 | 10,234 | 9,807 | |

On line—Word-1, Word-4 is in the search criteria so are discarded. Word-6 and Word-7 are new words. Word-6 rates highest, so add any new members not on list and add 1 to all members. Word-7 has occurred at a low level, so add any new members to the list and add 0.3 to all members.

One Line—Word-4 Word-3 and Word-6 are new. Word-3 is the most prominent, add any new members to the list and add 1 to all on the list. Word-6 runs second—add any new members and add 0.6 to all members.

On Line—Word-5 All three words are new, add any new members, for Word-3, add 1 to counter, for Word-7 add 0.6 to counter, and Word-6 add 0.3 to counter.

Display Order before GPS

The list of members thus far can be displayed in descending order

RDMS and SWA Flat Files

The member master file and associated skill categories are maintained in the RDMS. SWA matrixes, for performance purposes, are to be considered flat files for the purposes of the discussion.

In addition to the Cat1/Cat2 matrixes, SWA produces a master file of all words used. Currently this is a single file, member-IDs are linked. Performance can be optimised, if required, by breaking into separate file for each Category 1.

Rebuild—Accumulation

Using these matrixes in a sectionalised way (Per Primary Category) allows rebuild of matrixes as required—need a routine to do this—run at night or offline etc.

Why? We will have some trouble with new or split words that may slip into the matrixes e.g. Hong Kong could end up as two “Word” lines in the matrix—Kong & Hong. So we would need to rebuild some or all of matrixes as time goes on.

This also applies to a disaster recovery situation.

In Use

An individual wishing to become a subscriber logs onto the skills database website via the Internet and is directed to a screen such as depicted in the exemplary data input screen of FIG. 4. After entering mandatory data and payment of the subscription fee, the subscriber is directed to list the skills and talents he or she wishes to offer to potential users. Mandatory data will include personal details, email address and a geographic location indicator. This last may include national, regional and post code information where available.

Optionally, the subscriber may include a resume and may also provide details of licences, educational qualifications and any preferences. Preferences may include a limitation on the geographic area in which the skills and talents are offered and time periods at which they are available for example.

In effect the deposited data forms a “skill signature” of the subscriber; a uniquely structured file that includes not only the member's primary occupational and skill profile, but also their secondary array of professional, vocational or personal skills and experience that the member believes represent his or her unique value to an employer or other potential user.

An internal search engine of the database analyses key words and word associations in the skills, experience and talents listed and in any of the other optional information provided by the subscriber. These are made available for searching by potential users when entering the database.

As well, the internal search engine may generate and make available to members regular reports on the most frequent search patterns so that each member will be able to assess the relevance and value of their particular skill and talent set to potential employers and users. This feedback allows members to iteratively modify the skill and talent data in the database to more closely align the manner in which it is presented with perceived preferences of the skill “market”. The database managing entity may, in addition to this database generated material, provide useful information, such as relevant published articles and reports, to appropriate member groups.

It will be readily appreciated that the system offers great flexibility to subscribing members. Subscribing members as well as initiating and providing the skill data retain editorial control of the data at all times. Thus skill data stored on the database may be edited by a member at any time, for example to add newly acquired skills, change the emphasis or focus from one skill to another, or to change the geographical area in which the skill is offered.

The above describes only some embodiments of the present invention and modifications, obvious to those skilled in the art, can be made thereto without departing from the scope and spirit of the present invention.

1. A membership based skills data dissemination system; said system adapted to accept postings of personal skills data of respective ones of fee paying subscribing members; each subscribing member instigating and controlling their said personal skills data on a searchable database; said personal skills data including data comprising a description of at least one skill of each said subscribing member.

2. The system of claim 1 wherein said system further includes a feedback facility adapted to advising a said subscribing member on ways of optimizing content and format of said skills data.

3. The system of claim 2 wherein said feedback facility provides advice to a said subscribing member based on statistical analysis of subscribing member and potential user interactions recorded by said database.

4. The system of claim 3 wherein said feedback facility may include dissemination to a said subscribing member of articles and other information relevant to any skill of said subscribing member retained on said database.

5. The system of claim 4 wherein said wide ambit of skills includes both vocational and non-vocational skills.

6. The system of claim 5 wherein said non-vocational skills include skills associated with recreational activities.

7. The system of claim 5 wherein said non-vocational skills include skills associated with domestic activities

8. The system of claim 5 wherein said non-vocational skills include educational skills.

9. The system of claim 1 wherein said at least one skill includes skills offered by a said subscribing member on a permanent basis.

10. The system of claim 1 wherein said at least one skill includes skills offered by a said subscribing member on an ad hoc time basis.
